(19) United States
(12) Patent Application Publication
(10) Pub. No.: US 2010/0119780 A1
(43) Pub. Date: May 13, 2010

(54) Body with a Surface Structure Which Enhances the Friction Behavior

(75) Inventors: Andreas Schilling, Hagendorn (ZG) (CH); Stanislav N. Horb, Kiel-Suchsdorf (DE); Michael Varenberg, Hafia (IL)

Correspondence Address: HOFFMANN & BARON, LLP, 6900 JERICHO TURNPIKE, SYOSSET, NY, 11791, US

(73) Assignees: OVD KINEGRAM AG, Zug, (ZG) (CH); Max-Planck-Gesellschaft zur Forderung der Wissenschaften e.V., Munchen (DE)

(21) Appl. No.: 12/578,266

(22) Filed: Oct. 13, 2009

(30) Foreign Application Priority Data
Oct. 14, 2008 (DE) 102008051474.8-43

(51) Int. Cl. B32B 3/10; B60S 1/38

(52) U.S. Cl. 428/172; 428/156

(57) ABSTRACT

Described is a body, comprising an elastomeric material or having an outer elastomeric layer, wherein a surface structure which enhances the friction behavior is formed into the surface of the elastomeric body or into the outer elastomeric layer of the body. The surface structure (1) has a pattern made up of protuberances (11) which are prismatically, frusto-pyramidally, cylindrically, frusto-conically or mushroom-shaped, are spaced apart by passages (12) and the surfaces of which define a common plane, the maximum surface area of the protuberance (11) being in the range of from 100 nm to 5 mm.

### CROSS-REFERENCE TO RELATED APPLICATIONS

This application claims priority to German Application No. DE102008051474.8-43, filed Oct. 14, 2008, the specification of which is incorporated herein in its entirety for all purposes.

### BACKGROUND OF THE INVENTION

The invention relates to a body, comprising an elastomeric material or having an outer elastomeric layer, wherein a surface structure which enhances the friction behavior is formed into the surface of the elastomeric body or into the outer elastomeric layer of the body.

The friction behavior of the surface of a body in motion plays an important role in numerous technical applications. In liquid media, for example in oil, the frictional force can, in comparison to a dry surface, decrease considerably, as a result of which a friction gear can slip, for example.

On the other hand, in the case of dry surfaces, a so-called “stick-slip effect” can occur, in which the temporal frictional force profile continuously changes drastically, with the result that vibrations are triggered which manifest themselves as squeaking and chatter. Examples of this are squeaking rail vehicles and chattering windshield wiper blades.

### SUMMARY OF THE INVENTION

It is an object of the present invention to specify a body having a surface structure with enhanced friction behavior.

According to the invention, this object is achieved by way of a body, comprising an elastomeric material or having an outer elastomeric layer, wherein a surface structure which enhances the friction behavior is formed in a region of the body into the surface of the elastomeric body or into the outer elastomeric layer of the body, and wherein the surface structure has a large number of protuberances which are, in particular, prismatically, frusto-pyramidally, cylindrically, frusto-conically or mushroom-shaped, are spaced apart by passages and the end faces of which define a common plane, the maximum surface area of the end faces of the protuberances in each case being in the range of from 100 nm to 5 mm.

The body having the suggested surface structure is characterized in that a liquid is displaced from the surface of the protuberances by way of the surface, which is pressed on with a contact pressing force, of a body which meshes with the elastomeric body, and is guided away via the passages. The effect is supported by the protuberances deforming and giving way under load. Thus, regions, which remain substantially free of liquid even when in contact with a liquid-coated surface and which therefore still provide sufficient frictional force even under these conditions, are provided on the surface of the elastomeric body with the aid of the surface structure according to the invention.

Furthermore, the stick-slip effect, which occurs particularly when dry surfaces are paired, is eliminated. The stick-slip effect refers to the jerky sliding motion of solid bodies which move against one another. Here a rapid movement sequence of sticking, tensing, separating and sliding off of the contacting surfaces occurs. The vibrations generated in the process can be emitted in the form of a sound. Examples are the squeaking of a train or tram while travelling around bends or during braking, and chattering windscreen wipers on dry car panes. The decrease in the stick-slip effect on the surface of the body according to the invention can be explained by the protuberances, which are formed in the surface, being movable substantially independently from one another and the jerky sliding motion now only occurring at those few protuberances which cannot move out of the way.

The region, in which the surface structure is formed in the body, can here comprise the entire surface of the body or merely some of the surface of the body in which the friction behavior of the body is intended to be enhanced.

Like thermoplastics and thermosets, elastomers belong to the polymers. Elastomers are dimensionally stable but elastically deformable polymers, the glass transition temperature of which is below room temperature and the long-chain macromolecules of which are crosslinked with wide meshes and in random distribution. Material properties such as strength and viscosity can be adjusted by way of the degree of crosslinking and the degree of polymerization, which is a measure of the length of the macromolecules. The elastomers can deform under tensile loading and/or pressure loading, but subsequently retake their original, non-deformed shape. Elastomers are rubbery-elastic. A known example of elastomers is rubber. In a preferred embodiment, the material which is provided for the body complies with the definition specified in DIN 7724 for an elastomer.

It can be provided that the maximum dimension of the end faces of the protuberances is in each case in the range of from 100 nm to 1 mm, preferably from 0.5 μm to 1 mm. The maximum dimension is understood to mean the maximum width or longitudinal dimension. As has been found, the selection of the maximum dimension can be used to optimize the friction behavior either with respect to a maximum frictional force in liquid-covered surfaces or with respect to the avoidance of the stick-slip effect on dry surfaces. Here, the range of from 0.5 μm to 1 mm is particularly suited for avoiding the stick-slip effect.

It can be provided in one advantageous development that the maximum dimension of the end faces of the protuberances is in each case less than 300 μm.

The range from 100 nm to 300 μm can be preferred for the development of haptic properties.

Furthermore it can be provided that the end faces of the protuberances of the surface structure have a uniform shape, in particular the shape of a square, of an isosceles triangle, regular hexagon or other regular polygon.

In one advantageous development it can be provided that the protuberances are arranged in hierarchical planes, with respectively smaller protuberances being arranged on larger protuberances. It is possible in this way to provide varying friction behavior for varying contact pressures. The protuberances arranged in the uppermost, i.e. in the outermost, plane can be flattened under increasing contact pressure, with the result that the protuberances, which have a larger area and are arranged in the plane located thereunder, are activated and so forth, if other planes are present. It is possible in this manner to also combine several properties. For example, the uppermost plane can be optimized with respect to the stick-slip effect and a further plane can be optimized with respect to a maximum frictional force.

It can furthermore be provided that the protuberances have a rectangular, trapezoidal or mushroom-shaped longitudinal section. The longitudinal section is perpendicular to the plane defined by the end faces. The deformation behavior of the protuberances can be influenced and optimized by way of the selection of the longitudinal section of the protuberances. The designations “rectangular”, “trapezoidal” and “mushroom-shaped” relate to classes of longitudinal sections and do not preclude another longitudinal section, which cannot be categorized into one of said classes, from being provided. That means that a person skilled in the art does not need to preclude longitudinal sections which exhibit good behavior in the trial when they do not fit into the abovementioned classes. In the case of a trapezoidal longitudinal section, for example, which tapers in the direction of the end face of the protuberance, the width of the upper end side can be in the micrometer range, such that it can be interpreted macroscopically as a triangular cross section.

It can be provided that the height of the protuberances is 1% to 1000% of the maximum dimension of the end face of the respective protuberance. The height of the protuberances is measured from the deepest point in the passages to the end face of the protuberance.

It can furthermore be provided that the height of the protuberances is 1% to 100% of the maximum dimension of the end face of the respective protuberance. This range is preferred for forming surface structures which increase the frictional force in liquid-covered surfaces. It is thus avoided that the protuberances tilt under loading. As has been shown, this range is advantageous in particular in conjunction with protuberances, which have a maximum surface area in the range of from 500 nm to 5 mm, in order to achieve particularly good friction behavior.

It can furthermore be provided that the area percentage of the end faces of the protuberances of the total area of the end faces of the protuberances and passages is in the range of from 5% to 99%.

It can be provided in another advantageous embodiment that the area percentage of the end faces of the protuberances of the total area is in the range of from 20% to 99%. Another parameter for adjusting the friction behavior is provided by the selection of the area percentage of the protuberances in relation to the total area of the surface. The previously mentioned range is preferred for forming surfaces without stick-slip effect.

It can be provided that the passages have an angled cross section, for example a rectangular, triangular or trapezoidal cross section. Between prism-shaped protuberances and between cylindrical protuberances, which like the prism-shaped protuberances have a rectangular longitudinal section, the passages have, by way of example, a rectangular cross section. Passages, which are formed between frusto-pyramidal or frusto-conical protuberances, have a triangular cross section if the lower sides of adjacent protuberances coincide, otherwise a trapezoidal cross section. The passages, which are formed between adjacent protuberances, thus have a cross section which is complementary to the longitudinal section through the protuberances.

However, it can also be provided that the passages have a cross section without sides, for example a circular or elliptic cross section.

The passages can be designed as passages in parallel arrangement, which form a cross pattern, for example. The longitudinal passage axis can be rectilinear or curved. The passages are advantageously designed such that they enclose the protuberances.

The surface structures according to the invention can be introduced into the surface by way of a tool during production of the surface. By way of example, an elastomeric material can be injection-molded around any desired body, such as a roller, wherein the surface of the injection molding forms the mold for forming the surface structure.

It is furthermore possible that a web-shaped elastomeric body is stamped during its production or deformed afterwards, for example thermoformed. It can be provided that it is deformed in a state in which it does not yet have rubbery-elastic behavior.

The stamping or molding tool can be designed as a negative mold by etching, lithography, laser ablation or other techniques suitable for microstructuring.

It can also be provided that the body is a film, in particular a laminating or transfer film. The surface structure can thus be formed, for example, into a transfer layer of the transfer film. Transferring the transfer layer is possible particularly advantageously onto planar or roller-type bodies, with it being possible for surfaces of a body to be coated at a later stage, for example on the occasion of maintenance or repair.

It can be provided that the surface, which is provided with the surface structure, of the body forms an anti-slip surface, in particular on substrates which are covered by liquids.

It can furthermore be provided that the surface, which is provided with the surface structure, of the body forms an anti-stick-slip surface, in particular on dry substrates.

The body according to the invention or the layer according to the invention can have various applications, for example

as screen wiper blade,

as elastic seal,

for holding apparatuses and grippers,

to improve haptics,

for condoms,

for shoes and gloves,

for hand prostheses,

for injection pistons or their abutments,

for hydraulic pistons or their abutments,

for pane seals for movable vehicle panes,

as anti-slip surface and

as anti-stick-slip surface.

The body according to the invention can also be used in safety engineering.

Provided may be a security element having at least one first haptically detectable region, in which the security element has a body according to the invention and in which the at least one first haptically detectable region is formed by the surface of the surface structure of said body.

Furthermore, the security element may have a second haptically detectable region, the haptic properties of which differ from the haptic properties of the at least one first haptically detectable region. It is possible by way of example for the security element to be a security document, such as a banknote, in which regions, which are not visually detectable, are haptically detectable and represent a security feature.

### BRIEF DESCRIPTION OF THE DRAWINGS

The invention will now be explained in more detail on the basis of exemplary embodiments. In the figures:

FIG. 1a shows a first exemplary embodiment of a body having a surface structure according to the invention in three-dimensional representation;

FIG. 1b shows a second exemplary embodiment of a body having a surface structure according to the invention in three-dimensional representation;

FIG. 2 shows a comparison representation of the friction in various environments for unstructured surfaces and surfaces which are structured according to the invention;

FIG. 3 shows a comparison diagram of the friction for unstructured surfaces and surfaces which are structured according to the invention;

FIG. 4 shows a diagram of the temporal profile of the frictional force and the normal force for an unstructured surface in a dry environment;

FIG. 5 shows a diagram of the temporal profile of the frictional force and the normal force for a surface according to the invention in a dry environment;

FIG. 6 shows a diagram of the temporal profile of the frictional force and the normal force for an unstructured surface in an environment which is soiled by oil;

FIG. 7 shows a diagram of the temporal profile of the frictional force and the normal force for a surface according to the invention in an environment which is soiled by oil;

FIG. 8 shows a third exemplary embodiment of a body having a surface structure according to the invention in schematic plan view;

FIG. 9a shows a schematic sectional representation of a first variant of the body in FIG. 8 along the sectional line IX-IX in FIG. 8;

FIG. 9b shows a schematic sectional representation of a second variant of the body in FIG. 8 along the sectional line IX-IX in FIG. 8;

FIG. 9c shows a schematic sectional representation of a third variant of the body in FIG. 8 along the sectional line IX-IX in FIG. 8.

### DETAILED DESCRIPTION OF THE INVENTION

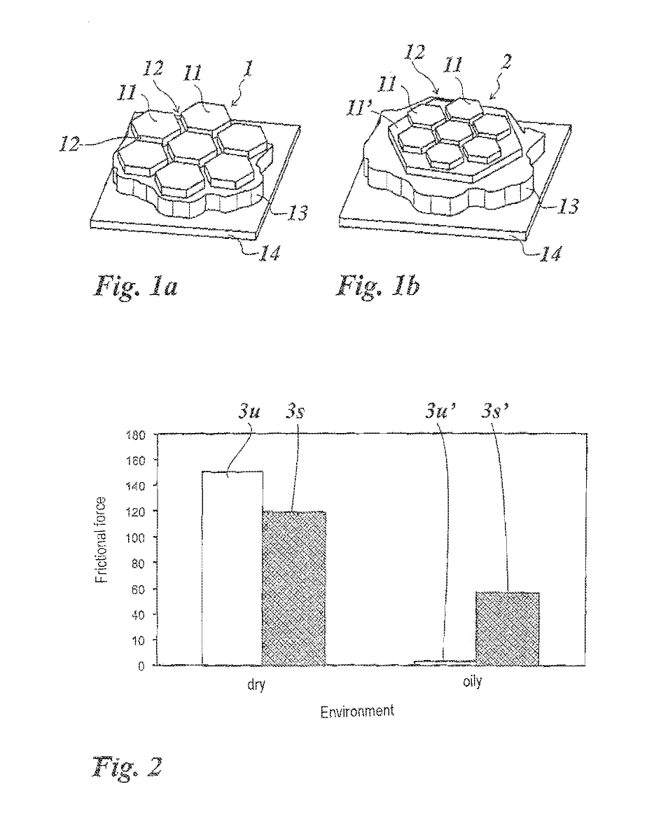

FIG. 1a shows a detail of a body 14 having a surface structure 1 which has a large number of uniformly shaped protuberances 11 which are separated from one another by passages 12. The protuberances 11 are formed into a structured layer 13, which is arranged on the body 14, and form a pattern, preferably a micro-pattern. The surface structure 1 can also be formed in the body 14 if it is an elastomeric body, with the result that the structured layer 13 is an integral part of the body. If the body 14 is a body having a planar surface or having a singly curved surface, such as a roller surface, for example, the structured layer 13 can be designed advantageously as a film or as a film layer. It may be, for example the transfer layer of a transfer film, for example of a hot stamping film. However, it is also possible for the structured layer 13 to be a layer which is applied by injection molding or casting, and into which the protuberances 11 are formed for example by way of a form die or in an injection molding. The protuberances 11 can preferably be prismatically, cylindrically or mushroom-shaped protuberances. In the exemplary embodiment shown in FIG. 1a, the protuberances 11 are designed as prismatic protuberances having an end face which is designed as a regular hexagon. The end faces are located in a common plane which forms the outer surface of the structured layer 13.

It is essential for the function (described below) of the surface structure 1 that the structured layer 13 is formed from an elastomeric material, for example from rubber or an elastomeric plastic.

The maximum surface area of the end faces of the protuberances 11 can be, for example, approximately 10 μm. In the exemplary embodiment shown in FIG. 1a, the end faces of the protuberances 11 are designed as regular hexagons. The maximum surface area of the protuberances 11 is thus the distance between two opposite corners of the hexagon. The geometric shape of the end face of the protuberances 11 is, however, not limited to the hexagon, in particular the regular hexagon. The protuberances 11 can also have, by way of example, a rectangular, in particular square, triangular or circular end face. Regular hexagons, squares and equilateral triangles can be preferred because they can form an area-filling pattern in a particularly simple manner.

The passages 12, which separate adjacent protuberances 11 from one another, have a rectangular cross section. However, they can also have another cross section, such as a triangular or circular cross section. As can be furthermore seen in FIG. 1a, the height of the protuberance 11 is the distance between the passage bottom and the upper edge or the end face of the protuberance.

FIG. 1b shows, in a further exemplary embodiment, a surface structure 2 which differs from the surface structure 1 shown in FIG. 1a in that protuberances 11 and 11′ are arranged in hierarchical planes one above the other. The protuberances 11 now form an upper plane and are arranged, in groups, on protuberances 11′, which form another plane arranged under the first plane. In the exemplary embodiment shown in FIG. 1b, in each case seven protuberances 11 are arranged on one protuberance 11′. In order to simplify the illustration, FIG. 1b does not show that the protuberances 11′ also form a pattern, which can be designed in an analogous manner to the arrangement of the protuberances 11.

The surface structure according to the invention generally causes two effects as compared with a nonstructured, smooth surface, specifically the prevention of the stick-slip effect on dry surfaces and the increase of frictional force on surfaces coated with liquid, for example surfaces coated with water or oil. The stick-slip effect refers to the jerky sliding motion of solid bodies which move against one another. Here a rapid movement sequence of sticking, tensing, separating and sliding off of the contacting surfaces occurs. The vibrations generated in the process can be emitted in the form of a sound. Examples are the squeaking of a train or tram while travelling around bends or during braking, and chattering windscreen wipers on dry car panes. Since the protuberances 11 formed in the surface are movable in a substantially mutually independent manner and the jerky sliding motion now only occurs at the few protuberances which cannot move out of the way, the stick-slip effect is eliminated, as will be described in more detail below.

Due to the microstructuring, the surface is decomposed into small area sections, wherein the liquid is guided by the area sections into the passages which are arranged between the surface sections and is removed there.

FIG. 2 shows a comparative illustration of the frictional conditions in different environments for nonstructured surfaces and structured surfaces according to the invention. The results determined in test series are illustrated in the form of a bar chart, the height of the bar representing the mean magnitude of the frictional force measured between the surface of a test body and a smooth underground.

In the case of a dry smooth underground and a nonstructured surface, the highest frictional force 3u was measured at 150 mN. It was higher than the frictional force 3s, which was measured at 120 mN for a dry underground and a structured surface. The measurements were now repeated for an oil-coated underground. The frictional force 3u′ measured for the pairing of the nonstructured surface with the oil-coated underground was the smallest one of the measured frictional forces at 2 mN. The frictional force 3u′ was so low that practically no power transmission between the two surfaces was possible anymore or the friction was negligible. The frictional force 3u′ was now only 1.3% of the original value. Compared to that, the frictional force 3s′, which was measured for the pairing of the structured surface with the oil-coated underground, was, at 55 mN, smaller than the frictional force 3s measured for the dry underground, but still sufficient for reliable force transmission. The frictional force 3s′ was still 50% of the original value.

Another advantageous effect of the surface structure according to the invention is the elimination of the so-called stick-slip effect which occurs on dry surfaces.

FIG. 3 shows a basic diagram of a time-dependent friction profile 4u on an unstructured surface and, in comparison, friction profiles 4s and 4s′ on a surface according to the invention. The friction profile 4u on the unstructured surface is typical for the stick-slip effect. The coefficient of friction initially rises continuously and then shows up and down spikes in rapid succession, which result in the above-described disturbing vibrations. Compared to that, the friction profiles 4s and 4s′ show no stick-slick effect on the surface according to the invention. Rather, after the initial increase in the coefficient of friction, a substantially constant coefficient of friction is established. The differing average coefficient of friction for friction profiles 4s and 4s′ is the result of varying depth-to-width ratios, also known as “aspect ratio”. The depth-to-width ratio is the ratio of the height of the protuberances 10 or 10′ to the diameter of the cross section. The friction profile 4s was measured for a low depth-to-width ratio, the low friction profile 4s′ was measured for a high depth-to-width ratio. As the depth-to-width ratio increases, the coefficient of friction decreases, both on dry and on liquid-covered surfaces.

As has furthermore been shown, the surface structure according to the invention can be optimized by way of the selection of the characteristic dimensions for optimum adherence, i.e. for an optimum coefficient of friction or for a low stick-slip effect.

TABLE 1

| | Optimization for high | Optimization for low |
|---|---|---|
| | friction coefficient in | stick-slip effect on dry |
| | the liquid | surfaces |
| maximum dimension of | 0.5 μm to 5 mm | 0.5 μm to 5 mm |
| the protuberances | | |
| height of the | 1% to 100% of the | 1% to 1000% of the |
| protuberances | maximum dimension | maximum dimension |
| | of the end faces | of the end faces |
| area percentage of the | 20% to 99% | 20% to 99% |
| end faces of the | | |
| protuberances in | | |
| relation to the total area | | |

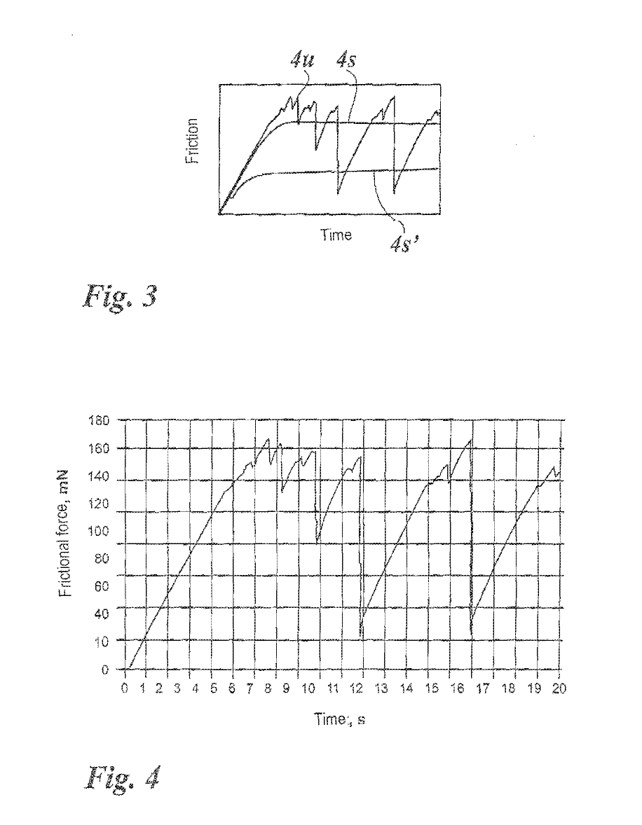

FIGS. 4 to 7 now show diagrams of the temporal profile of the frictional force for the measurements described further above in FIG. 2. The continuous curve denotes the frictional force.

FIG. 4 shows the temporal profile of the frictional force for a nonstructured surface in a dry environment (pos. 3u in FIG. 2). The frictional force has the fluctuating profile (described in more detail above in FIG. 3) which is typical of the stick-slip effect.

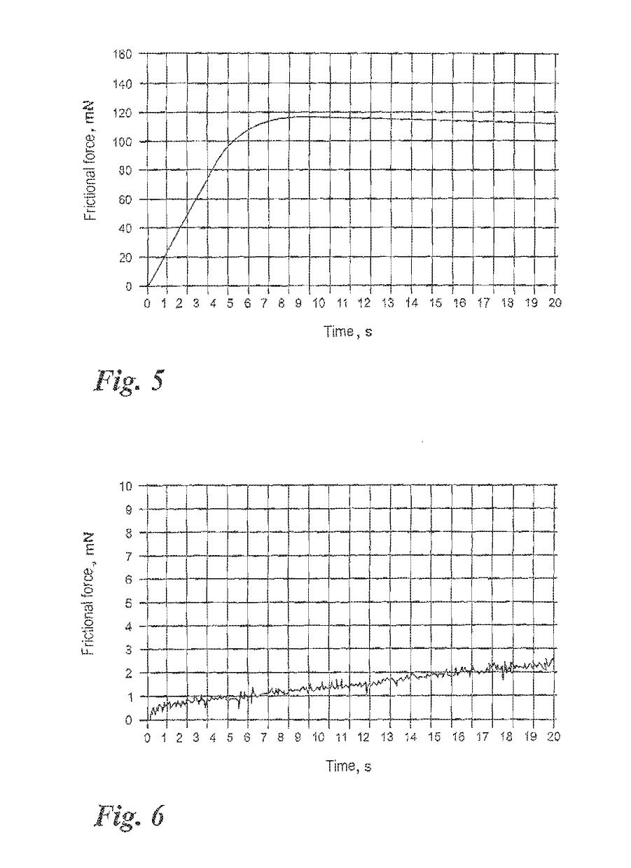

FIG. 5 shows the temporal profile of the frictional force for a structured surface in a dry environment (pos. 3s in FIG. 2). The frictional force has the profile described in more detail above in FIG. 3, that is to say no stick-slip effect occurs for the structured surface according to the invention.

FIG. 6 shows the temporal profile of the frictional force for a nonstructured surface in an oil-soiled environment (pos. 3u′ in FIG. 2). No stick-slip effect can be observed here (the fluctuations in the curve profile are caused by the measuring instrument).

FIG. 7 shows the temporal profile of the frictional force for a structured surface in an oil-soiled environment (pos. 3s′ in FIG. 2). There is no stick-slip effect. Compared to FIG. 6, the frictional force is considerably higher as a result of the surface structure according to the invention of the test body.

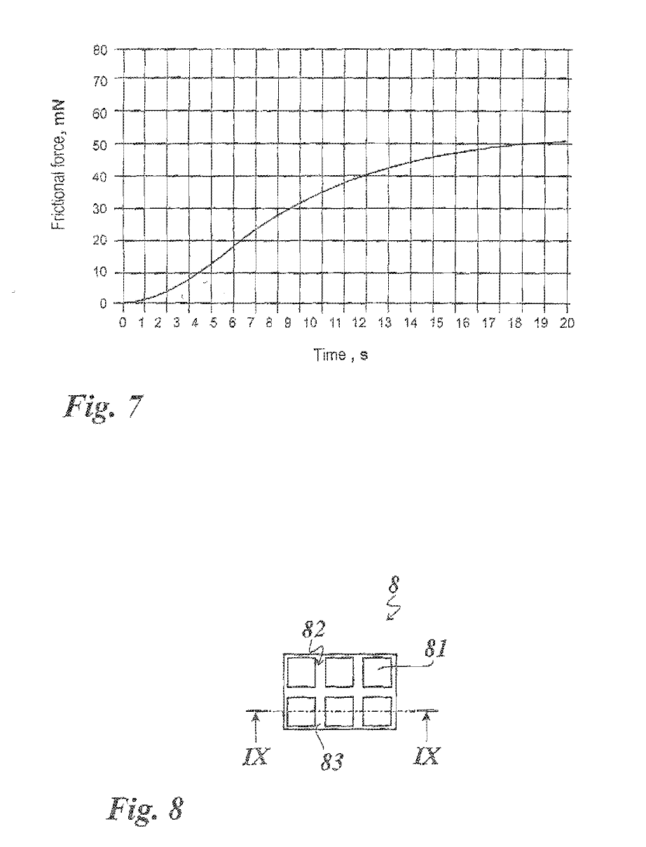

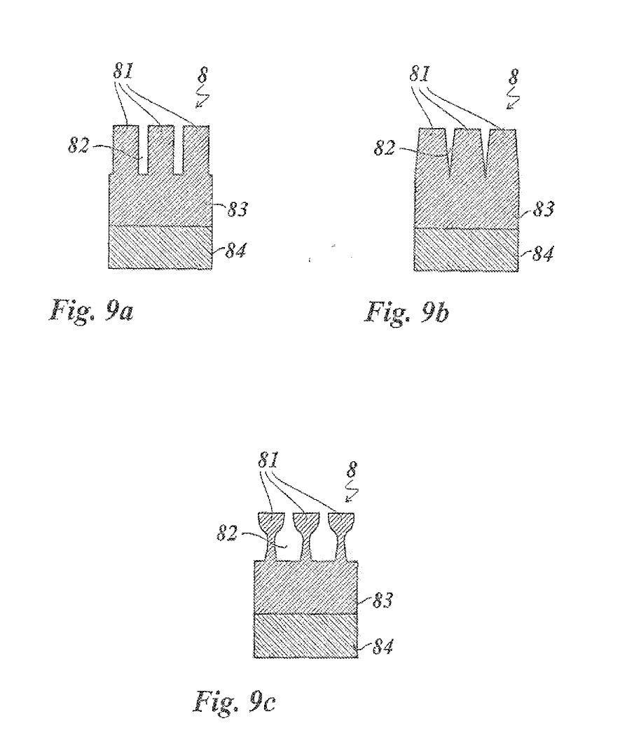

FIG. 8 now shows a plan view of a body 84 (see FIGS. 9a to 9c) having a surface structure 8, which is formed in a structured layer 83 and is made up of protuberances 81 with square end faces. The end faces of the protuberances 81 are arranged in one plane, as are the bottom areas of the protuberances 81. Passages 82 are formed between adjacent protuberances 81, with the bottom area of the passages 82 extending in the plane of the bottom areas of the protuberances 81.

FIGS. 9a to 9c show different variants of the protuberances in FIG. 8, which differ in terms of the shapes of their longitudinal sections. FIGS. 9a to 9c are schematic illustrations which do not represent the true dimensional proportions.

FIG. 9a shows protuberances 81 which are designed as prism-shaped protuberances. Consequently, their longitudinal section has a rectangular shape. A rectangular longitudinal section would also be characteristic of cylindrical protuberances which have a circular or elliptic end face. The passages 82, which are formed between adjacent protuberances 81, have a rectangular cross section.

FIG. 9b shows protuberances 81 which are designed as frusto-pyramidal protuberances. Consequently, their longitudinal section has a trapezoidal shape. A trapezoidal longitudinal section would also be characteristic of frusto-conical protuberances which have a circular or elliptic end face. The passages 82, which are formed between adjacent protuberances 81, have a triangular cross section if, as shown in FIG. 9b, the lower sides of adjacent protuberances 81 coincide. The passages 82 can also have a trapezoidal cross section, however, if the lower sides of adjacent protuberances 81 are spaced apart from one another.

FIG. 9c shows protuberances 81 which are designed as mushroom-shaped protuberances. Consequently, their longitudinal section has a mushroom shape. A mushroom-shaped longitudinal section would also be characteristic of mushroom-shaped protuberances which have a circular or elliptic or hexagonal end face instead of the square end face. The passages 82, which are formed between adjacent protuberances 81, have a cross section which is complementary to the longitudinal section through the protuberances 81.

In the exemplary embodiments illustrated in FIGS. 9a to 9c, the passages 82 are designed as prismatic passages in parallel arrangement, which form a cross pattern. For cylindrical or frusto-conical protuberances, the passages can have, for example, a rectangular, triangular, trapezoidal or complementarily mushroom-shaped cross section, but the cross section varies at least in terms of its dimensions along the longitudinal passage axis, which can also form a curved line rather than a straight line. The passages are advantageously designed such that they enclose the protuberances.

### LIST OF REFERENCES

1,2,8 surface structure
3s, 3s′ coefficients of friction for structured surface
3u, 3u′ coefficients of friction for unstructured surface
4s, 4s′ friction profile for structured surface
4u friction profile for unstructured surface
11, 11′, 81 protuberance
12, 82 passage
13, 83 structured layer
14, 84 body

1. A body, comprising an elastomeric material or having an outer elastomeric layer, wherein a surface structure which enhances the friction behavior is formed in a region of the body into the surface of the elastomeric body or into the outer elastomeric layer of the body, and wherein the surface structure has a large number of protuberances which are prismatically, frusto-pyramidally, cylindrically, frusto-conically or mushroom-shaped, are spaced apart by passages and the end faces of which define a common plane, the maximum surface area of the end faces of the protuberances in each case being in the range of from 100 nm to 5 mm.

2. A body according to claim 1, wherein the maximum dimension of the end faces of the protuberances is in each case in the range of from 100 nm to 1 mm.

3. A body according to claim 1, wherein the maximum dimension of the end faces of the protuberances is in each case less than 300 μm.

4. A body according to claim 1, wherein the end faces of the protuberances of the surface structure have a shape of a square, of an isosceles triangle, regular hexagon or other polygon.

5. A body according to claim 1, wherein the protuberances are arranged in hierarchical planes, with respectively smaller protuberances being arranged on larger protuberances.

6. A body according to claim 1, wherein the protuberances have a rectangular, trapezoidal or mushroom-shaped longitudinal section.

7. A body according to claim 1, wherein the height of the protuberances is 1% to 1000% of the maximum dimension of the end face of the respective protuberance.

8. A body according to claim 7, wherein the height of the protuberances is 1% to 100% of the maximum dimension of the end face of the respective protuberance.

9. A body according to claim 1, wherein the area percentage of the end faces of the protuberances of the total area of the end faces of the protuberances and passages is in the range of from 5% to 99%.

10. A body according to claim 9, wherein the area percentage of the end faces of the protuberances of the total area of the end faces of the protuberances and passages is in the range of from 20% to 99%.

11. A body according to claim 1, wherein the passages have a hexagonal, rectangular, triangular, trapezoidal or polygonal cross section.

12. A body according to claim 1, wherein the passages have a circular or elliptic cross section.

13. A body according to claim 1, wherein the body is a laminating or transfer film.

14. A body according to claim 1, wherein the surface, which is provided with the surface structure, of the body forms an anti-slip surface.

15. A body according to claim 1, wherein the surface, which is provided with the surface structure, of the body forms an anti-stick-slip surface.

16. A body according to claim 1, wherein the body is a screen wiper blade.

17. A body according to claim 1, wherein the body is an elastic seal.

18. A security element having at least one first haptically detectable region, wherein the security element has a body according to claim 1, and wherein at least one first haptically detectable region is formed by the surface of the surface structure of said body.

19. A security element according to claim 18, wherein the security element has a second haptically detectable region, the haptic properties of which differ from the haptic properties of the at least one first haptically detectable region.

20. Use of the body according to claim 1 as an anti-slip surface.

21. Use of the body according to claim 1 as an anti-stick-slip surface.
